(19) United States
(12) Patent Application Publication
(10) Pub. No.: US 2022/0137671 A1
(43) Pub. Date: May 5, 2022

(54) WOOD PANEL ASSEMBLIES FOR PALM REST AND TRACKPAD

(71) Applicant: Hewlett-Packard Development Company, L.P., Spring, TX (US)

(72) Inventors: Marcus Townsend, Spring, TX (US); Sandie Ning-Ning Cheng, Spring, TX (US); Guan-Bai Chen, Taipei City (TW)

(73) Assignee: Hewlett-Packard Development Company, L.P., Spring, TX (US)

(21) Appl. No.: 17/297,176

(22) PCT Filed: Jul. 15, 2019
(86) PCT No.: PCT/US2019/041843

§ 371 Date: May 26, 2021

(51) Int. Cl. G06F 1/16

(52) U.S. Cl. CPC G06F 1/1662; G06F 1/1616; G06F 1/169

(57) ABSTRACT

Example wood panel assemblies that are disposed on electronic devices are disclosed. In an example, an electronic device includes a palm rest, and a trackpad disposed on the palm rest. In addition, the electronic device includes a wood panel assembly mounted on top of the palm rest and the trackpad. The wood panel assembly includes a wood veneer panel including a top surface and a bottom surface. The bottom surface covers the palm rest and the trackpad. In addition, the wood panel assembly includes a fabric material secured along the bottom surface.

### BACKGROUND

Electronic devices (e.g., such as laptop computers) may include a palm rest on which a user may rest their palms (or other portions of the user's hand). For laptop computers, the palm rest may be located on a side of a keyboard which faces the user during operations. In addition, some electronic devices may also include a touch sensitive surface (e.g., a trackpad) that serves as a user input device or area for the electronic device. In certain designs, the touch sensitive surface may be located along the palm rest.

### BRIEF DESCRIPTION OF THE DRAWINGS

Various examples will be described below referring to the following figures:

FIG. 1 is a perspective view of an electronic device including a wood panel assembly according to some examples disclosed herein;

FIG. 2 is a top, schematic view of the electronic device and wood panel assembly of FIG. 1 according to some examples;

FIG. 3 is an top, schematic exploded view of the electronic device and wood panel assembly of FIG. 1 according to some examples;

FIG. 4 is a schematic cross-sectional view of the palm rest of the electronic device with the wood panel assembly disposed therein according to some examples; and

FIG. 5 is a block diagram of a method of constructing and mounting a wood panel assembly to an electronic device according to some examples.

### DETAILED DESCRIPTION

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

As previously described, electronic devices may include a palm rest on which a user may rest their palms and/or other portions of the hand during operations. As a result, the palm rest may serve as a consistent point of physical contact between users and the electronic device. Thus, one may wish to include a visually and tactilely appealing layer or cover on the palm rest so as to enhance user satisfaction. Wood (e.g., natural wood, laminate wood, etc.) may be a suitable candidate for the covering of a palm rest since it provides a warm and natural appearance and may be more tactilely satisfactory to a user than a fully manufactured surface or material. Accordingly, examples disclosed herein include wood panel assemblies for covering a palm rest area of an electronic device. In some examples, the wood panel assemblies may also cover a trackpad that is disposed along the palm rest area, such that a continuous wood covering or panel assembly may be disposed across the palm rest and trackpad area of the electronic device.

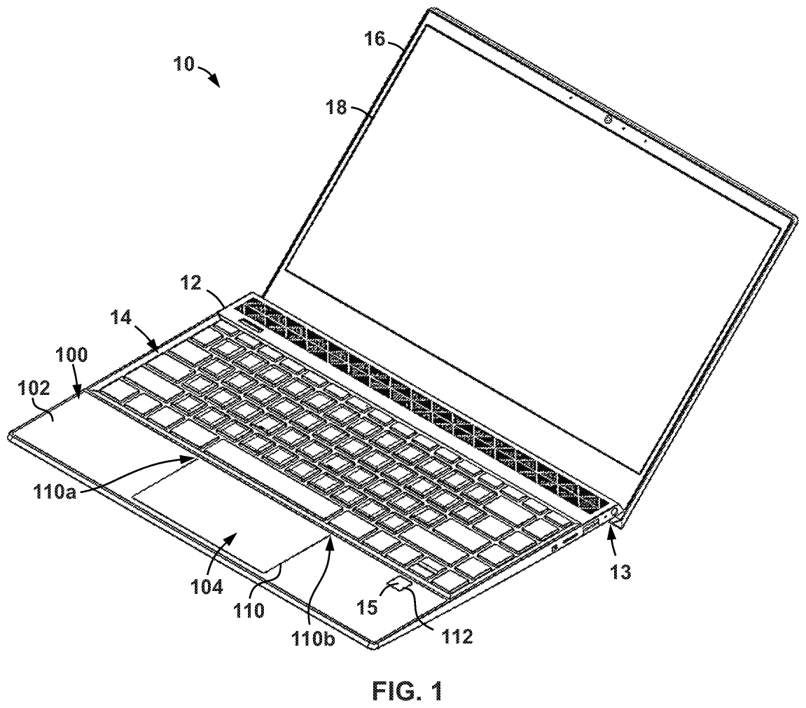

Referring now to FIGS. 1-3, an electronic device 10 according to some examples is shown. As used herein, the term “electronic device,” refers to a device that is to carry out machine readable instructions, and may include internal components, such as, processors, power sources, memory devices, etc. For example, an electronic device may include, among other things, a personal computer, a smart phone, a tablet computer, a laptop computer, a personal data assistant, an e-reader, etc. In this example, electronic device 10 is a laptop computer that includes a first housing member 12 rotatably coupled to a second housing member 16 at a hinge 13.

The second housing member 16 includes an electronic display 18 (or more simply “display 18”) that is to project images for viewing by a user (not shown) of the electronic device 10. In some examples, display 18 may be a flexible display; however, display 18 may not be a flexible display in other examples. As used herein, the term “display” refers to an electronic display (e.g., a liquid crystal display (LCD), an organic light emitting diode (OLED) display, a plasma display, an electrophoretic display, etc.) that is to display images generated by an associated electronic device. The term “flexible display” refers to an electronic display that may be deformed (e.g., rolled, folded, etc.) within a given parameter or specification (e.g., a minimum radius of curvature) without losing electrical function or connectivity.

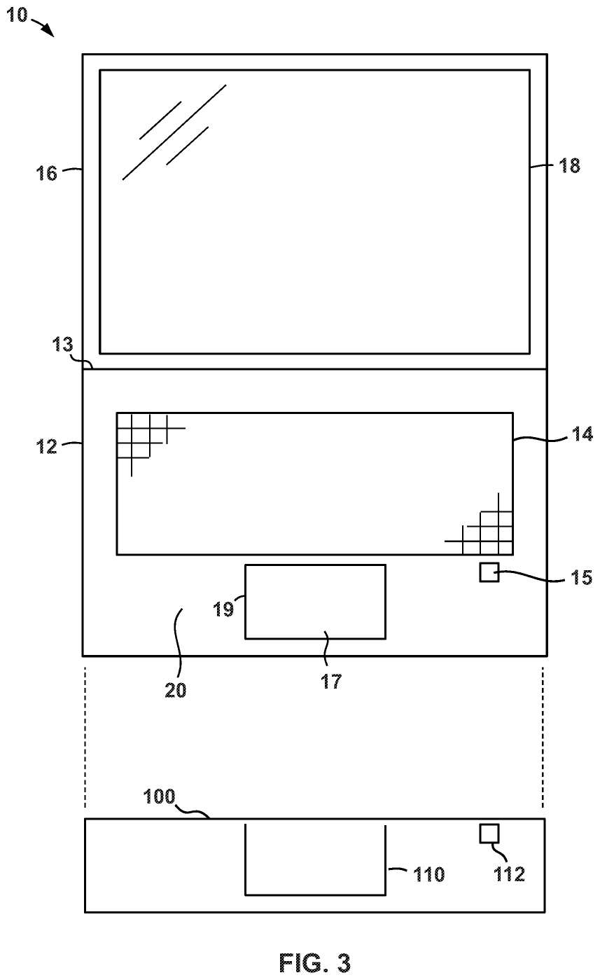

The first housing member 12 includes a user input device, such as, for example, a keyboard 14. In addition, as best shown in FIG. 3, first housing member 12 includes a palm rest 20 adjacent keyboard 14. Generally speaking, palm rest 20 is to serve as a location along first housing member 12 wherein a user may place their palms or hands while interacting with the electronic device 10 (e.g., such as when depressing keys on keyboard 14).

A trackpad 17 is disposed on palm rest 20. Trackpad 17 may comprise a touch sensitive surface that may receive user inputs during operation of electronic device 10. Trackpad 17 may utilize any suitable touch sensitive technology, such as, for instance, resistive touch sensitivity, capacitive touch sensitivity, acoustic wave touch sensitivity, etc. In addition to touch sensitive capabilities, trackpad 17 (or some portion thereof) may be depressed into first housing member 12 to initiate selections, functions, etc., on electronic device 10 (e.g., such as a mouse click). Thus, trackpad 17 (or again some portion thereof) may function like a button or plurality of buttons that may be depressed by a user during operations. Trackpad 17 may have a perimeter 19 that is formed to any suitable shape or size. In some examples (e.g., such as the example of FIGS. 1-3), trackpad 17 (and particularly perimeter 19) is generally rectangular in shape; however, other shapes are contemplated herein, such as round, oval, triangular, square, polygon, etc.

In addition, in some examples (e.g., the example of FIGS. 1-3), a biometric sensor 15 is disposed on palm rest 20, adjacent trackpad 17. Biometric sensor 15 may comprise any suitable device(s) that is to scan or read a user's fingerprint (e.g., a thumb print) in order to supply security credentials for an application being executed on electronic device 10.

Referring again to FIGS. 1-3, electronic device 10 also includes a wood panel assembly 100 mounted on top of the palm rest 20 and trackpad 17. Among other components and features (which are described in more detail below), wood panel assembly 100 includes a wood veneer panel 102. Specifically, wood veneer panel 102 may comprise an upper layer of the wood panel assembly 100 so that a user may see and feel the wood veneer panel 102 during use of electronic device 10.

In some examples, wood veneer panel 102 may comprise a single, continuous piece of natural wood. Any suitable type of wood may be used to construct wood veneer panel 102, such as, for instance, oak, birch, pine, spruce, maple, etc. In some examples, wood veneer panel 102 may comprise a composite or laminate of a plurality of pieces of wood (e.g., either the same wood type or multiple wood types) that are formed into a single veneer panel as shown.

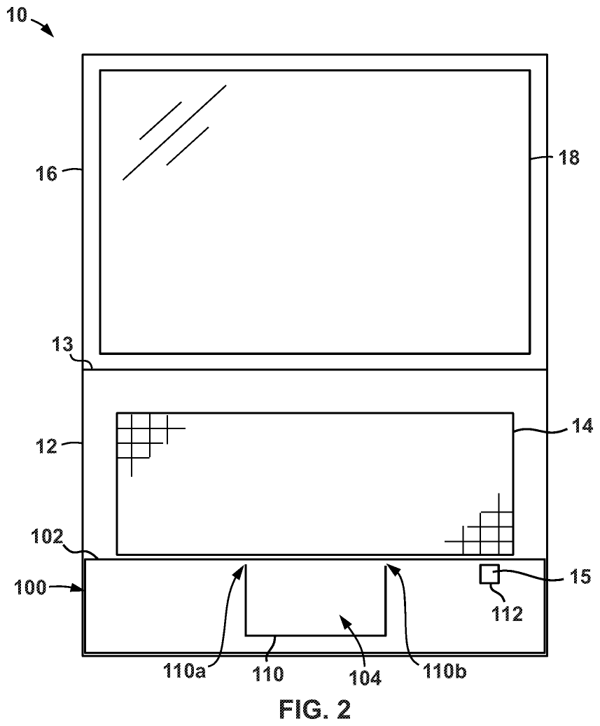

A U-shaped slot 110 is formed in wood panel assembly 100 (and thus through wood veneer panel 102). As may be best appreciated by FIG. 3, the slot 110 may be aligned with (or disposed along) a portion of perimeter 19 of trackpad 17 when wood panel assembly 100 is mounted to palm rest 20 (e.g., as shown in FIGS. 1 and 2). The slot 110 may extend from a first end 110a to a second end 110b, wherein the ends 110a, 110b do not meet or intersect. As a result, slot 110 forms or defines a first or trackpad region or portion 104 on wood panel assembly 100 that is disposed over trackpad 17. Because the ends 110a, 110b of slot 110 do not intersect, trackpad portion 104 remains connected to the other portions of wood veneer panel 102 (e.g., at and between ends 110a, 110b). During operations with electronic device 10, when a user depresses the trackpad 17 to make a selection as previously described above, the user engages with the trackpad portion 104 of wood panel assembly 100 such that both the underlying trackpad 17 and the trackpad portion 104 may be deflected relative to the rest of wood panel assembly 100. Thus, trackpad portion 104 is deflectable or otherwise movable relative to the rest of wood panel assembly 100 (including the remaining portions of wood veneer panel 102) via the slot 110.

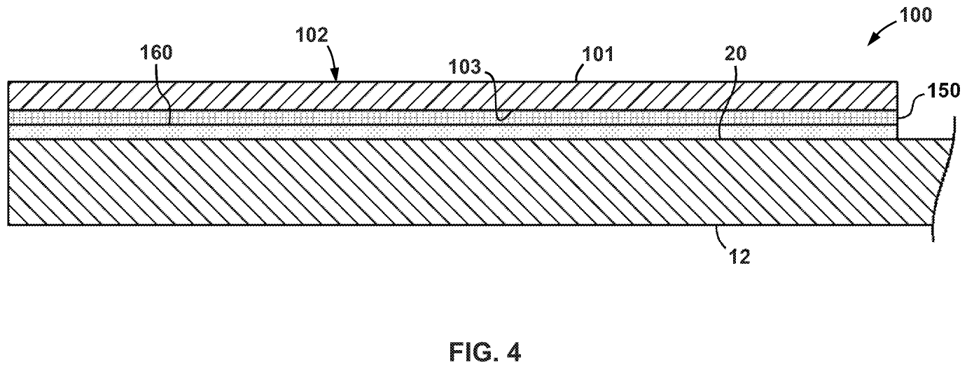

In addition, during operations, a user may apply touch inputs to a top surface of wood veneer panel 102 (e.g., top surface 101 described below and shown in FIG. 4) within trackpad region 104. Accordingly, the type and design of trackpad 17 as well as the thickness of wood panel assembly 100 may be arranged to allow touch inputs to trackpad portion 104 to be registered or sensed by trackpad 17. Thus, touch sensitive functionality of trackpad 17 may be maintained through wood panel assembly 100 (particularly through trackpad portion 104 as described above). In some examples, trackpad 17 may be specifically tuned or constructed to register touch inputs that are made to the trackpad portion 104. For instance, in some examples, the trackpad 17 may be calibrated to the porous structure of the wood veneer panel 102 and any adhesives that are utilized to attach the wood veneer panel 102 to trackpad 17 (e.g., adhesive layer 160 discussed in more detail below). This calibration may also account for a porosity of the wood veneer panel 102 in some examples.

An aperture 112 may extend through wood panel assembly 100 (and thus through wood veneer panel 102) that is to align with biometric sensor 15 when wood panel assembly 100 is mounted to palm rest 20 (e.g., as shown in FIGS. 1 and 2). As a result, biometric sensor 15 is accessible by a user via the aperture 112 during operations. In some examples, biometric sensor 15 may be flush with, recessed below, or projected from a top or uppermost surface (e.g., top surface 101 described below and shown in FIG. 4) of wood panel assembly 100.

Referring now to FIGS. 3 and 4, wood veneer panel 102 may include a first or top surface 101 and a second or bottom surface 103 opposite the top surface 101. When wood panel assembly 100 is installed on electronic device 10, bottom side 103 of wood veneer panel 102 may cover the palm rest 20 and trackpad 17.

A fabric material 150 is secured to bottom surface 103. For instance, in some examples, fabric material 150 may be adhered to the bottom surface 103. Specifically, in some examples, fabric material 150 may be laminated along the bottom surface 103 with a suitable resin or other adhesive so as to bond the bottom surface 103 to the fabric material 150. In some examples, the fabric material 150 may comprise a non-woven mesh fabric, and may comprise a polymer material.

Without being limited to this or any other theory, the fabric material 150 may provide flexibility to the otherwise thin and brittle wood veneer panel 102. Accordingly, referring briefly to FIGS. 2 and 4, during operations when a user imparts a force or pressure to the wood panel assembly 102, the wood panel assembly 102 may appropriately deflect without fracturing. More particularly, as a result of the flexibility imparted by the fabric material 150, when a user depresses the trackpad portion 104 of wood veneer panel 102 as previously described above, the trackpad portion 104 may deflect relative to the other portions of wood veneer panel 102 without causing fractures at the connection between trackpad portion 104 and remaining portions of wood veneer panel 102 (e.g., about and between ends 110a, 110b of slot 110).

Referring again to FIGS. 3 and 4, together the wood veneer panel 102 and the fabric material 150 may be secured to palm rest 20 and trackpad 17 with a suitable adhesive 160. Adhesive 160 may comprise any suitable material for bonding wood veneer panel 102 and fabric material 150 to the material forming palm rest 20 and trackpad 17 (which may comprise a polymer, a metal, glass, or combinations thereof, etc.). In some examples, the adhesive 160 may comprise a thermally activated adhesive that may be cured via the application of thermal energy (e.g., heat). In some examples, the adhesive 160 may be activated at temperatures that do not cause damage to the wood veneer panel 102 and fabric material 150. In addition, as wood veneer panel 102 and fabric material 150 are being adhered to palm rest 20 and trackpad 17, some of the adhesive 160 may flow through fabric layer 150 and fill in gaps, pores, or other discontinuities in wood veneer panel 102 (e.g., along bottom surface 103). Without being limited to this or any other theory, by filling in the pores, gaps, etc. within wood veneer panel 102, fewer gaps or occlusions may exist between top surface 101 of wood veneer panel 102 and trackpad 17 so as to enhance the ability of trackpad 17 to register or detect touch inputs to top surface 101 during operations with electronic device 10.

In some examples, palm rest 20 and trackpad 17 may be processed and/or constructed so as to promote better bonding with wood panel assembly 100 via adhesive 160. For instance, in some examples the surface of palm rest 20 may be roughened (e.g., etched) prior to mounting the wood veneer panel 102 and fabric material 150 thereto via adhesive 160. In some of these examples, the palm rest 20 may be constructed from a metallic material (e.g., aluminum or an alloy thereof). Without being limited to this or any other theory, roughening palm rest 20 may promote better adhesion with wood panel assembly 100 (e.g., via adhesive 160). In addition, in some examples trackpad 17 may be constructed from glass, which may be better suited to withstand the thermal curing of adhesive 160 previously described above.

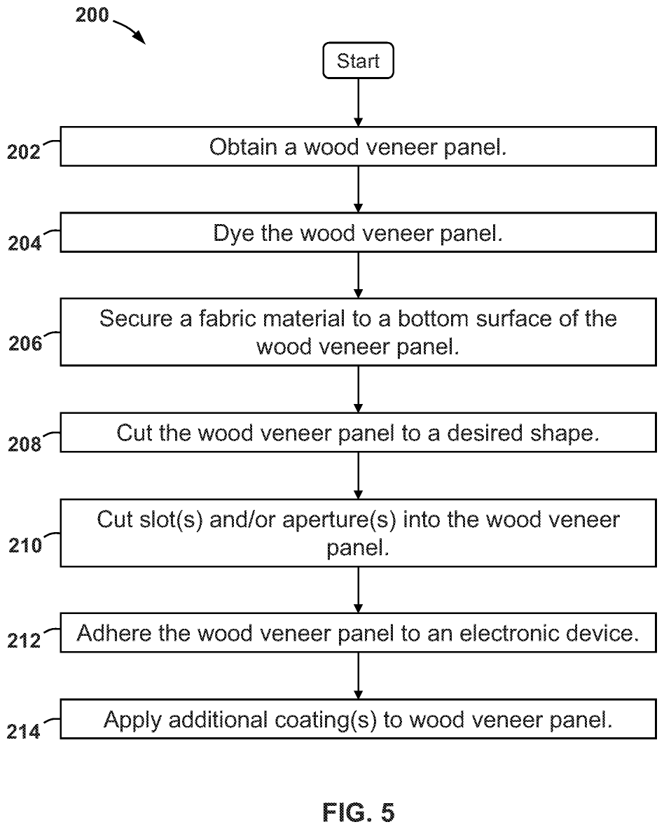

Referring now to FIG. 5, a method 200 of constructing and then installing a wood panel assembly (e.g., wood panel assembly 100) on a palm rest and trackpad (e.g., palm rest 20 and trackpad 17, respectively) of an electronic device (e.g., electronic device 10) is shown. In describing method 200, reference will be made to the electronic device 10 and wood panel assembly 100 of FIGS. 1-4; however, it should be appreciated that method 200 may be practiced with other systems and assemblies in other examples.

Initially, method 200 includes obtaining a wood veneer panel at 202. For instance, referring again to FIGS. 1-4, wood veneer panel 102 may be cut from a larger piece of natural wood, and/or may be a laminated veneer of a plurality of pieces of wood (e.g., from a single species or multiple species of wood as previously described above).

Referring again to FIG. 5, method 200 next includes dyeing the wood veneer panel at 204. The dyeing may include the use of colored dyes, stains, etc., to provide a desired color, shade, and/or finish to the wood veneer panel (e.g., wood veneer panel 102). In some examples, dyeing the wood veneer panel at 204 may include application of a chemical agent to alter a color of the wood, such as, for instance, a bleach solution (e.g., sodium hypochlorite, sodium percarbonate, etc.). In some examples, method 200 does not include block 204 such that the wood veneer panel (e.g., wood veneer panel 102) may retain its original (e.g., natural) coloring or shading.

In addition, method 200 includes securing a fabric material to a bottom surface of the wood veneer panel at 206. For instance, referring again to FIGS. 1-4, fabric material 150 may be secured to bottom surface 103 of wood veneer panel 102. As previously described above, fabric material 150 may be adhered, and specifically may be laminated onto the bottom surface 103 so as to bond fabric layer 150 and wood veneer panel 102.

Referring again to FIG. 5, method 200 also includes cutting the wood veneer panel to a desired shape at 208 and cutting slot(s) and/or aperture(s) into the wood veneer panel at 210. In some examples, the cutting at both 208 and 210 may be carried out in a single manufacturing stage. In other examples, the cutting at 208 may be carried out separately from the cutting at 210.

Referring again to FIGS. 1-4 in combination with FIG. 5, at block 208 of method 200, the wood veneer panel 102 (with or without the fabric material 150 secured thereto) may be cut into a desired shape so as to fit or cover the palm rest 20 and trackpad 17 as previously described above. In this example, the wood veneer panel 102 may be cut into a substantially rectangular shape; however, the specific shape and dimensions of the wood veneer panel 102 may be varied and will depend on the specific shape and arrangement of palm rest 20 and trackpad 17 during operations. In addition, at block 210 of method 200 (FIG. 5), the slot 110 and aperture 112 may be cut through into the wood veneer panel 102 (again, with or without the fabric material 150 secured thereto).

Any suitable cutting technique (or plurality thereof) may be used at blocks 208, 210. For instance, in some examples, blocks 208, 210 may utilize die cutting, laser cutting, saw cutting, a drill press, or any combination thereof. In some examples, die cutting or saw cutting may be used in lieu of laser cutting for some of the cuts performed at blocks 208, 210 so as to minimize the occurrence of burn marks in the wood veneer panel 102.

Referring again to FIG. 5, method 500 also includes adhering the wood veneer panel to an electronic device (e.g., electronic device 10) at 212. For instance, referring to FIGS. 1-4 in combination with FIG. 5, the wood veneer panel 102 and fabric material 150 are adhered to the palm rest 20 and trackpad 17 of electronic device 10. Any suitable adhesive may be used at block 212. For instance, as previously described above, any of the above described adhesives comprising adhesive 160 may be utilized to adhere the wood veneer panel 102 to the electronic device 10—particularly to palm rest 20 and trackpad 17.

In some examples, method 200 may additionally include roughening a surface of the electronic device prior to adhering the wood veneer panel thereto at 212. For instance, referring to FIGS. 1-4 in combination with FIG. 5, as previously described above palm rest 20 may be roughened (e.g., etched) prior to adhering wood panel assembly 100 thereto via adhesive 160 so as to promote a better bond between the wood panel assembly 100 and palm rest 20.

Referring again to FIG. 5, method 200 also includes applying additional coating(s) to the wood veneer panel at 214. In some examples, the additional coating may comprise so-called “UV coatings” that are to protect the wood veneer panel (e.g., upper surface 101 shown in FIG. 4) from UV radiation (e.g., from the sun). In other examples, the additional coating at block 214 may comprise a coating that is to seal or protect against liquids (e.g., water, soft-drinks, fruit juices, coffee, tea, etc.), and oils from user's hands, etc.

Accordingly, examples disclosed herein included wood panel assemblies (e.g., wood panel assembly 100) for covering a palm rest and trackpad of an electronic device (e.g., palm rest 20 and trackpad 17 of electronic device 10). As a result, the wood panel assembly may provide an aesthetically and tactilely appealing surface to enhance a user's interaction with the electronic device during operations.

While the example of FIGS. 1-4 has included a wood panel assembly 100 mounted to a palm rest 20 and trackpad 17 of a laptop style computer (e.g., electronic device 10), it should be appreciated that such wood panel assemblies may be applied to other portions of electronic device 10 and to other types of electronic devices entirely. For instance, in other examples, a wood panel assembly (e.g., wood panel assembly 100) may be applied to an outer surface of first housing member 12 and/or second housing member 16 of electronic device 10 (see e.g., FIGS. 1 and 2). In addition, in some examples, a wood panel assembly (e.g., wood panel assembly 100) may be applied to a stand-alone keyboard (e.g., wherein the keyboard may or may not also include a trackpad), such as along a palm rest area of such a keyboard.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the following discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value. As used herein, the terms “downstream” and “upstream” are used to refer to the arrangement of components and features within a printer or scanning device with respect to the “flow” of media through the printer or scanning device during operations. Thus, if a first component of such a device receives media after it is output from a second component of the device during operations, then the first component may be said to be “downstream” of the second component and the second component may be said to be “upstream” of the first component.

What is claimed is:

1. An electronic device, comprising:
a keyboard;
a palm rest adjacent the keyboard;
a trackpad disposed on the palm rest; and
a wood panel assembly mounted on top of the palm rest and the trackpad, wherein the wood panel assembly comprises:
a wood veneer panel including a top surface and a bottom surface, wherein the bottom surface covers the palm rest and the trackpad; and
a fabric material secured along the bottom surface.

2. The electronic device of claim 1, wherein the fabric material comprises a non-woven fabric material.

3. The electronic device of claim 2, wherein the wood panel assembly is adhered to the palm rest and the trackpad.

4. The electronic device of claim 3, wherein the wood panel assembly is adhered to the palm rest and the trackpad with a thermally cured adhesive.

5. The electronic device of claim 1, wherein the wood veneer panel comprises a U-shaped slot that is aligned with a perimeter of the trackpad.

6. An electronic device, comprising:
a palm rest;
a trackpad disposed on the palm rest;
a wood veneer panel including a top surface and a bottom surface, wherein the bottom surface covers the palm rest and the trackpad; and
a non-woven fabric material adhered along the bottom surface.

7. The electronic device of claim 6, wherein the wood veneer panel comprises a U-shaped slot that is aligned with a perimeter of the trackpad.

8. The electronic device of claim 7, wherein the wood panel assembly is adhered to the palm rest and the trackpad.

9. The electronic device of claim 8, wherein the wood panel assembly is adhered to the palm rest and the trackpad with a thermally cured adhesive.

10. The electronic device of claim 6, wherein the fabric material comprises a polymer material.

11. An electronic device, comprising:
a first housing member;
a second housing member pivotally coupled to the first housing member with a hinge;
a palm rest disposed on the first housing member;
a trackpad disposed on the palm rest; and
a wood panel assembly mounted on top of the palm rest and the trackpad, wherein the wood panel assembly comprises:
a wood veneer panel including a top surface and a bottom surface, wherein the bottom surface covers the palm rest and the trackpad, and wherein the wood veneer panel comprises a U-shaped slot that is aligned with a perimeter of the trackpad; and
a fabric material secured along the bottom surface.

12. The electronic device of claim 11, wherein the fabric material comprises a non-woven fabric mesh.

13. The electronic device of claim 12, wherein the fabric material comprises a polymer.

14. The electronic device of claim 13, wherein the wood panel assembly is adhered to the palm rest and the trackpad with a thermally cured adhesive.

15. The electronic device of claim 14, wherein the fabric material is adhered to the bottom surface.
